(19) United States
(12) Patent Application Publication
(10) Pub. No.: US 2022/0073745 A1
(43) Pub. Date: Mar. 10, 2022

(54) CURABLE SILICONE-BASED COMPOSITIONS AND APPLICATIONS THEREOF

(71) Applicant: Momentive Performance Materials Inc., Waterford, NY (US)

(72) Inventors: TITASH MONDAL, BENGAL (IN); PRAGATI GAHLOUT, Uttarakhand (IN); SHREEDHAR BHAT, Bangalore (IN)

(21) Appl. No.: 17/417,417

(22) PCT Filed: Dec. 18, 2019
(86) PCT No.: PCT/US2019/067013

§ 371 Date: Jun. 23, 2021

(30) Foreign Application Priority Data
Dec. 26, 2018 (IN) 201821049325

(51) Int. Cl. C08L 83/04; C08G 77/08; C08G 77/14; C08G 77/20; C08G 77/12; C08G 77/52; C08G 77/54; C08K 3/04; C08K 3/08; C08K 3/22; C08K 9/02

(52) U.S. Cl. CPC C08L 83/04; C08K 2201/001; C08G 77/14; C08G 77/20; C08G 77/12; C08G 77/52; C08G 77/54; C08K 3/041; C08K 3/08; C08K 3/22; C08K 9/02; C08L 2205/025; C08L 2203/20; C08K 2003/0812; C08K 2003/2265; C08G 77/08

(57) ABSTRACT

The present technology provides a curable silicone composition comprising a polymer A comprising one or more alkenyl functional groups; a polymer B comprising one or more hydride functional groups; and a filler, wherein at least one of polymer A and/or polymer B is a silicone polymer.

### CROSS REFERENCE TO RELATED APPLICATIONS

The preset application claims priority to and the benefit of India provisional application 201821049325 filed on Dec. 26, 2018, the disclosure of which is incorporated herein by reference in its entirety.

### FIELD

The present technology relates to curable silicone-based compositions. In particular, the present technology relates to a curable silicone-based composition comprising an alkenyl functionalized polymer, a hydride functionalized polymer, a filler, and a catalyst.

### BACKGROUND

Silicones are known for their inherent properties such as high thermal stability, flexibility, and/or chemical resistance. Siloxanes are used for electronic or electrical applications based on their properties such as those mentioned above. While it might be desirable to use siloxanes in applications where electrical conductivity may be important, developing electrically conductive siloxane materials is challenging.

Electrical properties can be achieved in silicones by adding fillers into the silicone matrix, and desired conductivity may be achieved by increasing the filler loading in the composition. At higher loadings, however, the filler particles may separate out from the composition over a period of time. Hence, the dispersion of fillers with higher loading in the siloxane matrix is a major challenge. Higher loadings of fillers in the composition may also adversely affect the curing kinetics and processability of the composition. Other common challenges include, but not limited to, variable contact resistance and volume resistivity.

To solve these technical problems, an effort was made to develop curable silicone compositions with desired mechanical and chemical properties. To solve these technical problems, an effort was made to develop curable silicone compositions with desired mechanical and chemical properties.

### SUMMARY

Provided is a curable silicone composition that can provide desired adhesion and other mechanical and chemical properties and even electrical properties. In some embodiments, the present technology provides a curable composition comprising a polymer A, a polymer B, one or more fillers, and a catalyst, wherein the polymer A includes organic units or siloxane units comprising one or more alkenyl functional groups, and the polymer B includes organic units, siloxane units, or combination of both organic units and siloxane units, wherein the organic units and siloxane units comprises one or more hydride functional groups. In some embodiments, the polymer B includes a hybrid silicone hydride.

In some embodiments, the polymer A can be represented by Formula 1:

(R)ₐ(W)_{b}(R)_{a″} Formula 1

wherein a and a″ can be zero but a+a″>0 and b cannot be zero,
R can be represented by Formula (1a):

(CH₂)_{c}(CH₂O)_{d}(CHOH)ₑ(S)_{f}(X)_{g} Formula (1a)

Formula (1a) may represent a linear chain or a branched chain. In Formula (1a), S is independently selected from a urea or urethane linkage, a cyclic structure with unsaturation, a saturated cyclic hydrocarbon, a heterocyclic group, a sulphone, a carbonate, a maleate, a phthalate, an adipate, and wherein X is represented by Formula (1b), Formula (1b′), or a combination of alkenyl radical of Formula (1b) and any one of the ring structure mentioned in Formula (1b′):

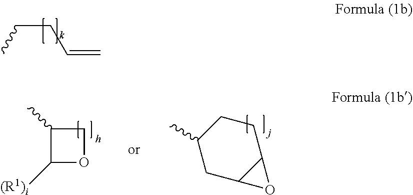

R₁ is selected from an aliphatic or an aromatic substituted hydrocarbon, or an un-substituted hydrocarbon, or fluorinated hydrocarbons having 1-20 carbon atoms and optionally connected to an ester, c, g, d, e, f, h, i, j, k can be zero or greater.
Further, W of Formula 1 can be represented by Formula (1c)

(Y)ₗ(z)ₘ Formula (1c)

wherein l, m can be zero or greater with the proviso that (l+m)>0; Y in Formula (1c) can be represented by Formula (1d)

(M₁)ᵤ(D₁)ₙ(D₂)ₒ(D*)ₚ(T₁)_{q}(Q₁)ᵣ(M₂)ᵥ Formula (1d)

wherein n, o are each always >0, and wherein u, p, q, r, and v can be zero or greater with the proviso that n+o+p+q+r+u+v>0;
M₁ is represented by Formula (1e)

R₂R₃R₄SiK_{1/2} Formula (1e)

D₁ is represented by Formula (10:

R₅R₆SiK_{2/2} Formula (1f)

D₂ is represented by Formula (1g):

R₇R₈SiK_{2/2} Formula (1g)

D* is represented by Formula (1h)

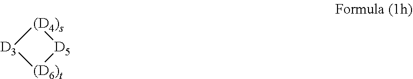

D₃ is represented by Formula (1i)

R₉R₁₀SiK_{2/2} Formula (1i)

D₄ is represented by Formula (1j)

R₁₁R₁₂SiK_{2/2} Formula (1j)

D₅ is represented by Formula (1k)

R₁₃R₁₄SiK_{2/2} Formula (1k)

D₆ is represented by Formula (1l)

R₁₅R₁₆SiK_{2/2} Formula (1l)

T₁ is represented by Formula (1m):

R₁₇SiK_{3/2} Formula (1m)

Q₁ is represented by Formula (1n):

SiK_{4/2} Formula (1n)

M₂ is represented by Formula (1o):

R₁₈R₁₉R₂₀SiK_{1/2} Formula (1o)

R₂-R₂₀ can be independently selected from R, a monovalent cyclic or acyclic, aliphatic or aromatic, substituted or un-substituted hydrocarbon, or a fluorinated hydrocarbon having 1-20 carbon atoms, and s and t can be zero or greater,
K is oxygen or (CH₂) group subject to the limitation that the molecule contains an even number of O_{1/2} and even number of (CH₂)_{1/2} and the O_{1/2} and (CH₂)_{1/2} groups both are all paired in the molecule.
Z in Formula (1c) is selected from the structure of Formula (1p):

R₂₁(J)_{w}R₂₂ Formula (1p)

wherein J can be independently selected from a monovalent cyclic or acyclic, aliphatic or aromatic, substituted or un-substituted hydrocarbon, or a fluorinated hydrocarbon having 1-carbon atoms, optionally connected to heteroatom, w≥0. Further, R₂₁, R₂₂ can be independently selected from R or from a monovalent cyclic or acyclic, aliphatic or aromatic, substituted or un-substituted hydrocarbon, or a fluorinated hydrocarbon having 1-20 carbon atoms, optionally connected to a heteroatom.

In some embodiments, the polymer B can be represented by Formula 2:

(R′)_{a′}(N′)_{b′}(R′)_{a′} Formula (2)

wherein a′, b′ are each greater than 0,
R′ can be represented by Formula (2a)

(M₃)_{l′}(D₇)_{c′}(D₈)_{d′}(D**)_{e′}(T₂)_{f′}(Q₂)_{g′}(M₄)_{m′} Formula (2a)

M₃ is represented by Formula (2b)

R₂₅R₂₆R₂₇SiK′_{1/2} Formula (2b)

D₇ is represented by Formula (2c)

R₂₈R₂₉SiK′_{2/2} Formula (2c)

D₈ is represented by Formula (2d)

R₃₀R₃₁SiK′_{2/2} Formula (2d)

D** is represented by Formula (2e)

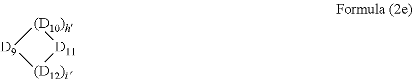

D₉ is represented by Formula (20

R₃₂R₃₃SiK′_{2/2} Formula (2f)

D₁₀ is represented by Formula (2g)

R₃₄R₃₅SiK′_{2/2} Formula (2g)

D₁₁ is represented by Formula (2h)

R₃₆R₃₇SiK_{2/2′} Formula (2h)

D₁₂ is represented by Formula (2i)

R₃₈R₃₉SiK′_{2/2} Formula (2i)

T₂ is represented by Formula (2j)

R₄₀SiK_{3/2′} Formula (2j)

Q₂ is represented by Formula (2k)

SiK_{4/2} Formula (2k)

M₄ is represented by Formula (2l)

R₄₁R₄₂R₄₃SiK′_{1/2} Formula (2l)

R₂₅-R₄₃ can be independently selected from hydrogen, a monovalent cyclic or acyclic, aliphatic or aromatic, substituted or un-substituted hydrocarbon, or a fluorinated hydrocarbon having 1-20 carbon atoms, c′, d′ is always >0, while e′, f′, l′, m′ and g′ can be zero with the proviso that c′+d′+e′+f′+g′+l′+m′>0, h′, i′>0 when e′>0, K′ is oxygen or a (CH₂) group subject to the limitation that the molecule contains an even number of O_{1/2} and even number of (CH₂)_{1/2} and the O_{1/2} and (CH₂)_{1/2} groups both are all paired in the molecule. W′ of Formula 2 can be selected from the structure of Formula (2m) or Formula (2m′):

R₄₄(J′)_{l″}R₄₅ Formula (2m)

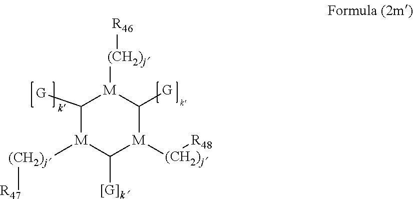

wherein J′ can be independently selected from a divalent cyclic or acyclic, aliphatic or aromatic, substituted or un-substituted hydrocarbon, or a fluorinated hydrocarbon having 1-20 carbon atoms, optionally connected to heteroatom, l″≥0. The cyclic structure represented in Formula (2m′) can also be aromatic. R₄₄-R₄₈ can be independently selected from R′ or from a monovalent cyclic or acyclic, aliphatic or aromatic, substituted or un-substituted hydrocarbon, or a fluorinated hydrocarbon having C₁-C₂₀ carbon atoms, optionally connected to heteroatom. G is a heteroatom selected from oxygen, M can be independently selected from carbon or nitrogen, k′ can be 0, j′ is greater than 1.

### DETAILED DESCRIPTION

In the following specification and the claims, which follow, reference will be made to a number of terms, which shall be defined to have the following meanings.

The singular forms “a”, “an” and “the” include plural referents unless the context clearly dictates otherwise. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, is not to be limited to the precise value specified. In some instances, the approximating language may correspond to the precision of an instrument for measuring the value.

As used herein, the term “aromatic” and “aromatic radical” are used interchangeably and refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthraceneyl groups (n=3) and the like. The aromatic radical may also include nonaromatic components. For example, a benzyl group is an aromatic radical which comprises a phenyl ring (the aromatic group) and a methylene group (the nonaromatic component). Similarly, a tetrahydronaphthyl radical is an aromatic radical comprising an aromatic group (C₆H₃) fused to a nonaromatic component (CH₂)₄. For convenience, the term “aromatic radical” or “aromatic” is defined herein to encompass a wide range of functional groups such as alkyl groups, alkenyl groups, alkynyl groups, haloalkyl groups, haloaromatic groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylphenyl radical is a C7 aromatic radical comprising a methyl group, the methyl group being a functional group which is an alkyl group. Similarly, the 2-nitrophenyl group is a C6 aromatic radical comprising a nitro group, the nitro group being a functional group. Aromatic radicals include halogenated aromatic radicals such as 4-trifluoromethylphenyl, hexafluoroisopropylidenebis(4-phen-1-yloxy) (i.e., —OPhC(CF₃)₂PhO—), 4-chloromethylphen-1-yl, 3-trifluorovinyl-2-thienyl, 3-tri chloromethylphen-1-yl (i.e., 3-CCl₃Ph-), 4-(3-bromoprop-1-yl)phen-1-yl (i.e., 4-BrCH₂CH₂CH₂Ph-), and the like. Further examples of aromatic radicals include 4-allyloxyphen-1-oxy, 4-aminophen-1-yl (i.e., 4-H₂NPh-), 3-aminocarbonylphen-1-yl (i.e., NH₂COPh-), 4-benzoylphen-1-yl, dicyanomethylidenebis(4-phen-1-yloxy) (i.e., —OPhC(CN)₂PhO—), 3-methylphen-1-yl, methylenebis(4-phen-1-yloxy) (i.e., —OPhCH₂PhO—), 2-ethylphen-1-yl, phenylethenyl, 3-formyl-2-thienyl, 2-hexyl-5-furanyl, hexamethylene-1,6-bis(4-phen-1-yloxy) (i.e., —OPh(CH₂)₆PhO—), 4-hydroxymethylphen-1-yl (i.e., 4-HOCH₂Ph-), 4-mercaptomethylphen-1-yl (i.e., 4-HSCH₂Ph-), 4-methylthiophen-1-yl (i.e., 4-CH₃SPh-), 3-methoxyphen-1-yl, 2-methoxycarbonylphen-1-yloxy (e.g., methyl salicyl), 2-nitromethylphen-1-yl (i.e., 2-NO₂CH₂Ph), 3-trimethylsilylphen-1-yl, 4-t-butyldimethylsilylphen-1-yl, 4-vinylphen-1-yl, vinylidenebis(phenyl), and the like. The term “a C3-C10 aromatic radical” includes aromatic radicals containing at least three but no more than 10 carbon atoms. The aromatic radical 1-imidazolyl (C₃H₂N₂—) represents a C3 aromatic radical. The benzyl radical (C₇H₇—) represents a C7 aromatic radical. In one or more embodiments, the aromatic groups may include C6-C30 aromatic groups, C10-C30 aromatic groups, C15-C30 aromatic groups, C20-C30 aromatic groups. In some specific embodiments, the aromatic groups may include C3-C10 aromatic groups, C5-C10 aromatic groups, or C8-C10 aromatic groups.

As used herein the term “cycloaliphatic group” and “cycloaliphatic radical” may be used interchangeably and refers to a radical having a valence of at least one, and wherein the radicalcomprises an array of atoms which is cyclic but which is not aromatic. As defined herein a “cycloaliphatic radical” does not contain an aromatic group. A “cycloaliphatic radical” may comprise one or more noncyclic components. For example, a cyclohexylmethyl group (C₆H₁₁CH₂—) is a cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. For convenience, the term “cycloaliphatic radical” is defined herein to encompass a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylcyclopent-1-yl radical is a C6 cycloaliphatic radical comprising a methyl group, the methyl group being a functional group which is an alkyl group. Similarly, the 2-nitrocyclobut-1-yl radical is a C4 cycloaliphatic radical comprising a nitro group, the nitro group being a functional group. A cycloaliphatic radical may comprise one or more halogen atoms which may be the same or different. Halogen atoms include, for example; fluorine, chlorine, bromine, and iodine. Cycloaliphatic radicals comprising one or more halogen atoms include 2-trifluoromethylcyclohex-1-yl, 4-bromodifluoromethylcyclooct-1-yl, 2-chlorodifluoromethylcyclohex-1-yl, hexafluoroisopropylidene-2,2-bis(cyclohex-4-yl) (i.e., —C₆H₁₀C(CF₃)₂C₆H₁₀—), 2-chloromethylcyclohex-1-yl, 3-difluoromethylenecyclohex-1-yl, 4-trichloromethylcyclohex-1-yloxy, 4-bromodichloromethylcyclohex-1-ylthio, 2-bromoethylcyclopent-1-yl, 2-bromopropylcyclohex-1-yloxy (e.g., CH₃CHBrCH₂C₆H₁₀O—), and the like. Further examples of cycloaliphatic radicals include 4-allyloxycyclohex-1-yl, 4-aminocyclohex-1-yl (i.e., H₂C₆H₁₀—), 4-aminocarbonylcyclopent-1-yl (i.e., NH₂COC₅H₈—), 4-acetyloxycyclohex-1-yl, 2,2-dicyanoisopropylidenebis(cyclohex-4-yloxy) (i.e., —OC₆H₁₀C(CN)₂C₆H₁₀O—), 3-methylcyclohex-1-yl, methylenebis(cyclohex-4-yloxy) (i.e., —OC₆H₁₀CH₂C₆H₁₀O—), 1-ethylcyclobut-1-yl, cyclopropylethenyl, 3-formyl-2-terahydrofuranyl, 2-hexyl-5-tetrahydrofuranyl, hexamethylene-1,6-bis(cyclohex-4-yloxy) (i.e., —OC₆H₁₀(CH₂)₆C₆H₁₀O—), 4-hydroxymethylcyclohex-1-yl (i.e., 4-HOCH₂C₆H₁₀—), 4-mercaptomethylcyclohex-1-yl (i.e., 4-HS CH₂C₆H₁₀—), 4-methylthiocyclohex-1-yl (i.e., 4-CH₃SC₆H₁₀—), 4-methoxycyclohex-1-yl, 2-methoxy carbonyl cyclohex-1-yloxy (2-CH₃OCOC₆H₁₀O—), 4-nitromethylcyclohex-1-yl (i.e., NO₂CH₂C₆H₁₀—), 3-trimethylsilylcyclohex-1-yl, 2-t-butyldimethylsilylcyclopent-1-yl, 4-tri methoxy silyl ethyl cyclohex-1-yl (e.g., (CH₃O)₃SiCH₂CH₂C₆H₁₀—), 4-vinyl cyclohexen-1-yl, vinylidenebis(cyclohexyl), and the like. The term “a C3-C10 cycloaliphatic radical” includes cycloaliphatic radicals containing at least three but no more than 10 carbon atoms. The cycloaliphatic radical 2-tetrahydrofuranyl (C₄H₇O—) represents a C4 cycloaliphatic radical. The cyclohexylmethyl radical (C₆H₁₁CH₂—) represents a C7 cycloaliphatic radical. In some embodiments, the cycloaliphatic groups may include C3-C20 cyclic groups, C5-C15 cyclic groups, C6-C10 cyclic groups, or C8-C10 cyclic groups.

As used herein the term “aliphatic group” and “aliphatic radical” are used interchangeably and refers to an organic radical having a valence of at least one consisting of a linear or branched array of atoms which is not cyclic. Aliphatic radicals are defined to comprise at least one carbon atom. The array of atoms comprising the aliphatic radical may include heteroatoms such as nitrogen, sulfur, silicon, selenium and oxygen or may be composed exclusively of carbon and hydrogen. For convenience, the term “aliphatic radical” is defined herein to encompass, as part of the “linear or branched array of atoms which is not cyclic” a wide range of functional groups such as alkyl groups, alkenyl groups, alkenyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylpent-1-yl radical is a C6 aliphatic radical comprising a methyl group, the methyl group being a functional group which is an alkyl group. Similarly, the 4-nitrobut-1-yl group is a C4 aliphatic radical comprising a nitro group, the nitro group being a functional group. An aliphatic radical may be a haloalkyl group which comprises one or more halogen atoms which may be the same or different. Halogen atoms include, for example; fluorine, chlorine, bromine, and iodine. Aliphatic radicals comprising one or more halogen atoms include the alkyl halides trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g., —CH₂CHBrCH₂—), and the like. Further examples of aliphatic radicals include allyl, aminocarbonyl (i.e., —CONH₂), carbonyl, 2,2-dicyanoisopropylidene (i.e., —CH₂C(CN)₂CH₂—), methyl (i.e., —CH₃), methylene (i.e., —CH₂—), ethyl, ethylene, formyl (i.e., —CHO), hexyl, hexamethylene, hydroxymethyl (i.e., —CH₂OH), mercaptomethyl (i.e., —CH₂SH), methylthio (i.e., —SCH₃), methylthiomethyl (i.e., —CH₂SCH₃), methoxy, methoxy carbonyl (i.e., CH₃OCO—), nitromethyl (i.e., —CH₂NO₂), thiocarbonyl, trimethylsilyl (i.e., (CH₃)₃Si—), t-butyldimethylsilyl, 3-trimethyoxysilylpropyl (i.e., (CH₃O)₃SiCH₂CH₂CH₂—), vinyl, vinylidene, and the like. By way of further example, a C1-C10 aliphatic radical contains at least one but no more than 10 carbon atoms. A methyl group (i.e., CH₃—) is an example of a C1 aliphatic radical. A decyl group (i.e., CH₃(CH₂)₉—) is an example of a C10 aliphatic radical. In one or more embodiments, the aliphatic groups or aliphatic radical may include, but is not limited to, a straight chain or a branched chain hydrocarbon having 1-20 carbon atoms, 2-15 carbon atoms, 3-10 carbon atoms, or 4-8 carbon atoms.

The present technology provides curable silicone-based compositions and the use of such compositions in a variety of applications. Selection of polymer A, polymer B, and one or more fillers as described herein in the composition provides a hybrid composite material with multifaceted properties. Further, the present compositions allow for the use of relatively high loadings of fillers in the silicone matrix without affecting the curing and processing conditions of the compositions. The presence of non-silicone organic units can be employed to provide additional benefits to the overall properties of the hybrid silicone composites.

One or more embodiments of the present technology provide a curable composition to form hybrid silicone composites. The curable composition comprises a polymer A, a polymer B, one or more fillers, and a catalyst. Polymer A comprises organic molecule or siloxane molecule comprising alkenyl functional groups, wherein polymer B comprises an organic molecule, a siloxane molecule, or a hybrid-siloxane molecule comprising hydride functional groups.

In some embodiments, the polymer A includes organic molecules comprising two or more alkenyl and/or epoxy functional groups, siloxane molecules comprising two or more alkenyl and/or epoxy functional groups, or a combination thereof. In some embodiments, the polymer A comprises organic molecules comprising two or more alkenyl and/or epoxy functional groups. In some other embodiments, the polymer A comprises siloxane molecules comprising two or more alkenyl and/or epoxy functional groups, wherein the alkenyl functionalized siloxane molecules are referred to hereinafter as “alkenyl silicone” and epoxy functionalized silicone is referred to herein as “epoxy silicone”. For example, in embodiments of polymer A, the siloxane may be functionalized with a “vinyl” group or, in another example, the siloxane may be functionalized with a “vinyl polyether” group. In some embodiments, the polymer A comprising an alkenyl silicone may be a linear polymer chain, wherein the alkenyl functional groups are attached to the terminal positions of the siloxane linear polymer. In some other embodiments, the polymer A comprising an alkenyl silicone may be a branched-polymer, wherein the alkenyl functional groups are attached to one or more pendant positions of the siloxane branched polymer. For other examples, in embodiments of polymer A, the siloxane may be functionalized with an “epoxy” group. In one or more embodiments, the polymer A may be a copolymer. In some embodiments, the copolymer A may be a random copolymer. In some other embodiments, the copolymer A may be a block copolymer. An example of a block copolymer may include a silicone polyether vinyl structure, wherein the silicone vinyl and silicone polyether units are present in an alternate arrangement.

Polymer A can be represented by a compound of the Formula 1:

(R)ₐ(W)_{b}(R)_{a″} Formula 1

wherein a and a″ can be zero but a+a″>0 and b cannot be zero, R can be represented by Formula (1a):

(CH₂)_{c}(CH₂O)_{d}(CHOH)ₑ(S)_{f}(X)_{g} Formula (1a)

Formula (1a) may represent a linear chain or a branched chain. In Formula (1a), S is independently selected from a urea or urethane linkage, a cyclic structure with unsaturation, a saturated cyclic hydrocarbon, a heterocyclic group, a sulphone, a carbonate, a maleate, a phthalate, an adipate, and wherein X is represented by Formula (1b), Formula (1b′), or a combination of an alkenyl radical of Formula (1b) and any one of the ring structures mentioned in Formula (1b′):

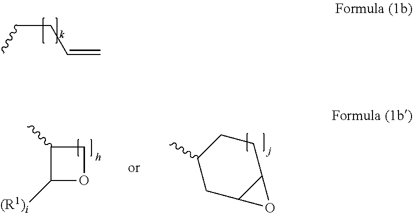

R₁ is selected from an aliphatic or aromatic substituted hydrocarbon, or an un-substituted hydrocarbon, or a fluorinated hydrocarbon having C₁-C₂₀ carbon atoms and optionally connected to an ester, c, g d, e, f, h, i, j, k can be zero or greater.
W of Formula 1 can be represented by Formula (1c)

(Y)ₗ(Z)ₘ Formula (1c)

wherein l, m can be zero or greater with the proviso that (l+m)>0; Y in Formula (1c) can be represented by Formula (1d)

(M₁)ᵤ(D₁)ₙ(D₂)ₒ(D*)ₚ(T₁)_{q}(Q₁)ᵣ(M₂)ᵥ Formula (1d)

wherein n, o, u, p, q, r, and v can be zero or greater with the proviso that n+o+p+q+r+u+v>0;
M₁ is represented by Formula (1e)

R₂R₃R₄SiK_{1/2} Formula (1e)

D₁ is represented by Formula (1f):

R₅R₆SiK_{2/2} Formula (1f)

D₂ is represented by Formula (1g):

R₇R₈SiK_{2/2} Formula (1g)

D* is represented by Formula (1h)

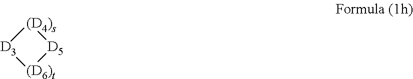

D₃ is represented by Formula (1i)

R₉R₁₀SiK_{2/2} Formula (1i)

D₄ is represented by Formula (1j)

R₁₁R₁₂SiK_{2/2} Formula (1j)

D₅ is represented by Formula (1k)

R₁₃R₁₄SiK_{2/2} Formula (1k)

D₆ is represented by Formula (1l)

R₁₅R₁₆SiK_{2/2} Formula (1l)

T₁ is represented by Formula (1m):
R₁₇SiK_{3/2} Wherein Q₁ is represented by Formula (1n):

SiO_{4/2} Formula (1n)

M₂ is represented by Formula (1o):

R₁₈R₁₉R₂₀SiK_{1/2} Formula (1o)

R₂-R₂₀ can be independently selected from R, a monovalent cyclic or acyclic, aliphatic or aromatic, substituted or un-substituted hydrocarbon, or a fluorinated hydrocarbon having Cᵣ C₂₀ carbon atoms. K is oxygen or (CH₂) group subject to the limitation that the molecule contains an even number of O_{1/2} and even number of (CH₂)_{1/2} and the O_{1/2} and (CH₂)_{1/2} groups both are all paired in the molecules and t can be 0 or greater.
Z in Formula (1c) is selected from the structure of Formula (1p):

R₂₁(J)_{w}R₂₂ Formula (1p)

wherein J can be independently selected from a divalent cyclic or acyclic, aliphatic or aromatic, substituted or un-substituted hydrocarbon, or a fluorinated hydrocarbon having Cᵣ C₂₀ carbon atoms, optionally connected to a heteroatom, w≥0, and R₂₁, R₂₂ can be independently selected from R or from a monovalent cyclic or acyclic, aliphatic or aromatic, substituted or un-substituted hydrocarbon, or a fluorinated hydrocarbon having C₁-C₂₀ carbon atoms, optionally connected to a heteroatom.

In embodiments, a and a″ are 1; b is 1; c, d, e, f, and g in R are independently 0-10, 1-8, or 2-6, and g is at least 1; h, i, k, and j are independently 0-10, 1-8, or 2-6; 1 is 1; m is 0; K is 0, and u, q, r, and v are independently at each occurrence 0-10. n, o, p, are independently at each occurrence 0-1000.

In embodiments, a and a″ are 1, b is 1, and W is Y where 1 is 1 and m is 0. In embodiments, Y is (D1)n(D2)o (D*)p such that polymer A is of the formula Ra-(D1)n(D2)o(D*)p-Ra″, where n is 0-1000, 1-750, 5-500, or 10-300, o is 0-1000, 1-750, 5-500, or 10-300, p is 0-100, R is independently (X)g, where k is 0-10, or R is (CH2)c(CH2O)d(X)g, where c is 0-10 and d is 0-10. In one embodiment, one of R5 or R6 in D1 is chosen from R, and R is independently (X)g. In one embodiment, o is 0, a is 0, and p is 1-10.

In some embodiments, polymer A as represented by formula 1 may include different structures as represented below (structures I-III and VIII-XIII). In one example of Polymer A, in formula 1, each of a, a″, b is 1, in formula 1(a), c is 4, d is 8, e, f are 0, g is 2, in formula 1 (b), k is 0, further in formula 1 (c) l is 1 when m is 0, further in formula 1 (d), u, and v are 1; n is 29, when each of o, p, q, r is 0, then the structure is:

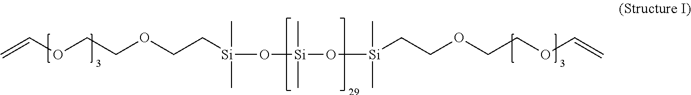

In one or more embodiments, Polymer A can be represented by the following structures:

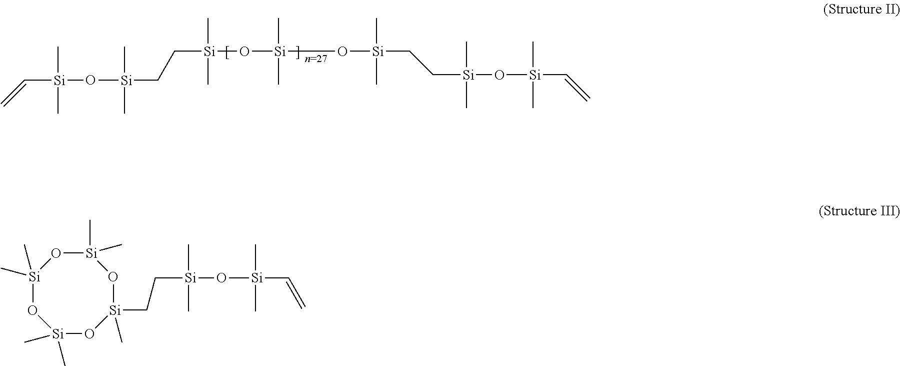

In one or more embodiments, Polymer A may also include the polymers represented by the following structures

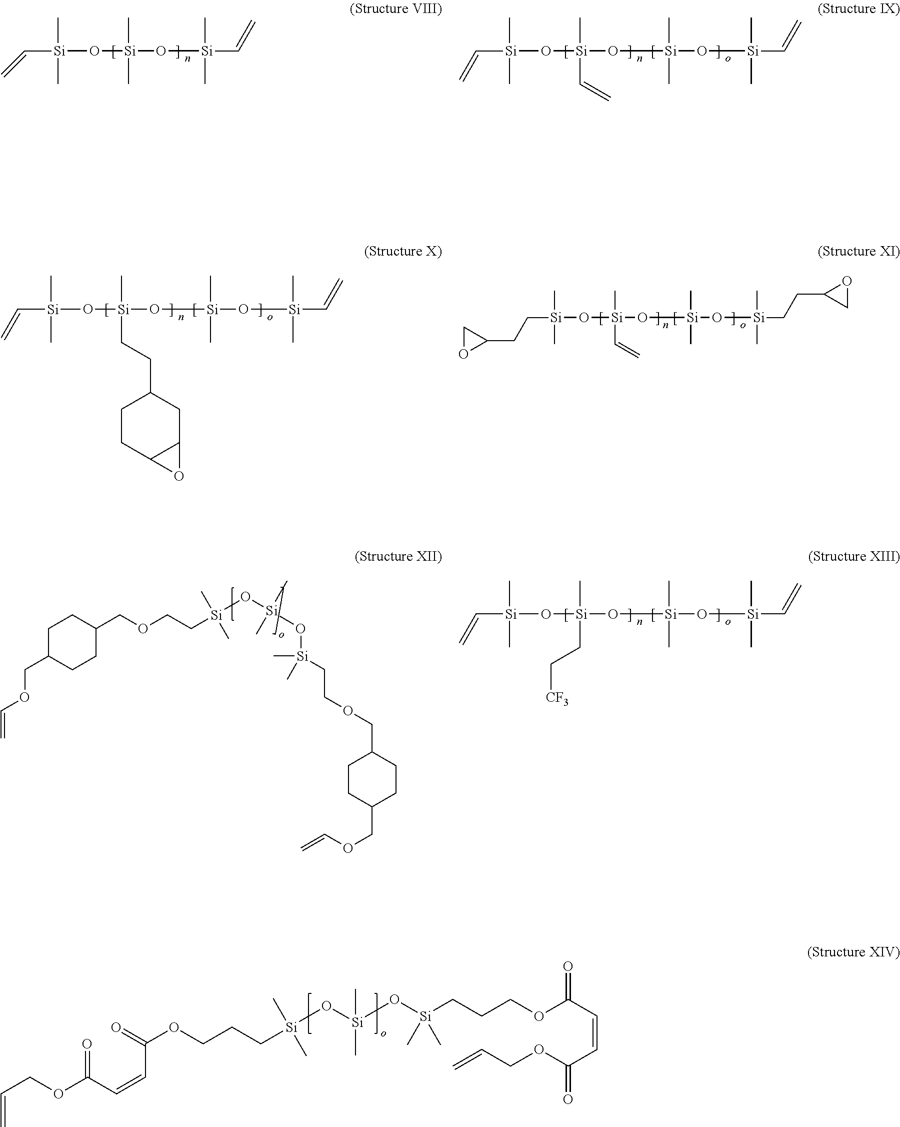

In one or more embodiments, the polymer B comprises an organic hydride, a silicone hydride, or a hybrid silicone hydride. In embodiments of the hybrid silicone hydride, the polymer B comprises both an organic unit and a silicone unit with two or more hydride functional groups. In some embodiments, the silicone hydride is a hybrid silicone hydride. The hybrid silicone hydride generally includes a combination of one or more silicone units comprising two or more hydride functional groups and one or more non-silicone organic units. In such embodiments of the hybrid silicone hydride, each of the silicone units and each of the organic units may be arranged in an alternate fashion. In another embodiment of the hybrid silicone hydride, two or more silicone units are separated by one or more organic units. In some embodiments, the hydride functional groups may either be in the terminal positions, or may be at the pendent position of the siloxane polymer chain of the silicone-hydride, or hybrid silicone hydride polymer.

In some embodiments, the polymer B can be represented by Formula 2:

(R′)_{a′}(W′)_{b′}(R′)_{a′} Formula (2)

wherein a′, b′ is greater than 0,
R′ can be represented by Formula (2a)

(M₃)_{l′}(D₇)_{c′}(D₈)_{d′}(D**)_{e′}(T₂)_{f′}(Q₂)_{g′}(M₄)_{m′} Formula (2a)

wherein M₃ is represented by Formula (2b)

R₂₅R₂₆R₂₇SiK′_{1/2} Formula (2b)

D₇ is represented by Formula (2c)

R₂₈R₂₉SiK′_{2/2} Formula (2c)

D₈ is represented by Formula (2d)

R₃₀R₃₁SiK′_{2/2} Formula (2d)

D** is represented by Formula (2e)

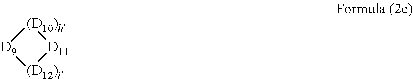

D₉ is represented by Formula (20

R₃₂R₃₃SiK′_{2/2} Formula (20

D₁₀ is represented by Formula (2g)

R₃₄R₃₅SiK′_{2/2} Formula (2g)

D₁₁ is represented by Formula (2h)

R₃₆R₃₇SiK_{2/2′} Formula (2h)

D₁₂ is represented by Formula (2i)

R₃₈R₃₉SiK′_{2/2} Formula (2i)

T₂ is represented by Formula (2j)

R₄₀SiK_{3/2′} Formula (2j)

Q₂ is represented by Formula (2k)

SiK_{4/2} Formula (2k)

M₄ is represented by Formula (2l)

R₄₁R₄₂R₄₃SiK′_{1/2} Formula (2l)

R₂₅-R₄₃ can be independently selected from hydrogen, a monovalent cyclic or acyclic, aliphatic or aromatic, substituted or un-substituted hydrocarbon, or a fluorinated hydrocarbon having C₁-C₂₀ carbon atoms, c′, d′, e′, f, l′, m′ and g′ can be zero or greater with the proviso that c′+d′+e′+f+g′+l′+m′>0, and h′, i′>0 when e′>0, K′ is oxygen or (CH₂) group subject to the limitation that the molecule contains an even number of O1/2 and even number of (CH₂)_{1/2} and the O_{1/2} and (CH₂)_{1/2} groups both are all paired in the molecule.
W′ of Formula 2 can be selected from the structure of Formula (2m) or Formula (2m′):

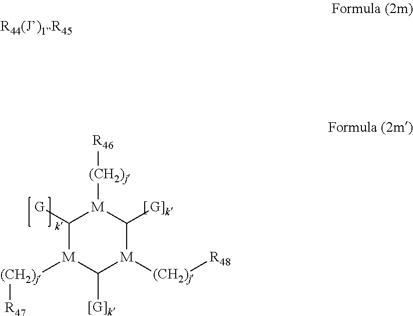

wherein J′ can be independently selected from a divalent cyclic or acyclic, aliphatic or aromatic, substituted or un-substituted hydrocarbon, or a fluorinated hydrocarbon having C₁-C₂₀ carbon atoms optionally connected to a heteroatom, and l″≥0. The cyclic structure represented in Formula (2m′) can also be aromatic. R₄₄-R₄₈ can be independently selected from W or from a monovalent cyclic or acyclic, aliphatic or aromatic, substituted or un-substituted hydrocarbon, or a fluorinated hydrocarbon having C₁-C₂₀ carbon atoms, optionally connected to heteroatom. G is selected from a heteroatom, such as oxygen, or (CH₂)ⱼ-R′. M can be independently selected from carbon or nitrogen, k′ can be 0 or greater, and j′ is greater than 1.

In embodiments, a′ is 1; b is 1; c′, d′, e′, f, and g′ in R are independently 0-10, 1-8, or 2-6, and h, i, are independently 0-10, 1-8, or 2-6; l′ is 1; m′ is 0; K′ is 0. Further, in some embodiments, l′, f, g′, and m′ are independently at each occurrence 0-10. c′, d′, e′, are independently at each occurrence 0-1000.

In embodiments, a′ is 1, b is 1, and W is R₄₄J′R₄₅ where 1″ is 1.

In some embodiments, R₂₁, R₂₂ of Formula (1p) of polymer A and R₄₄-R₄₅ of Formula (2m) of polymer B can be independently selected from tri (ethylene glycol), di (ethylene glycol), sulphone, carbonate, maleate, phthalate, adipate, urea, polyether, and perfluoropolyether.

In some embodiments, the polymer B, as represented by Formula 2, may be used as a cross-linker. In some other embodiments, the polymer B of Formula 2 can also be used as a chain extender. In one or more embodiments, the polymer B, represented by Formula 2, is a linear polymer. In some other embodiments, the polymer B, represented by Formula 2, is a branched polymer, wherein W′ of Formula 2 is selected from the structure of Formula (2m′). When W′ is selected from the cyclic structure of Formula (2m′), then a′ of Formula 2 can be 0. In such embodiments, R′ is also 0 and polymer B is represented by only W′, which can be a cross linker. For example, W′ is selected from silyl hydride of triazine or silyl hydride of cyclohexane.

In one or more embodiments, Polymer B can be represented by the following structures (IV VII, and XV-XVII):

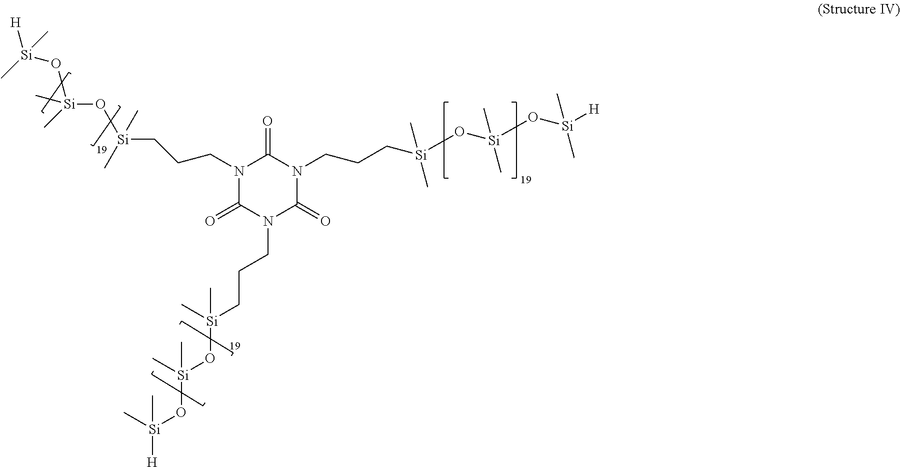

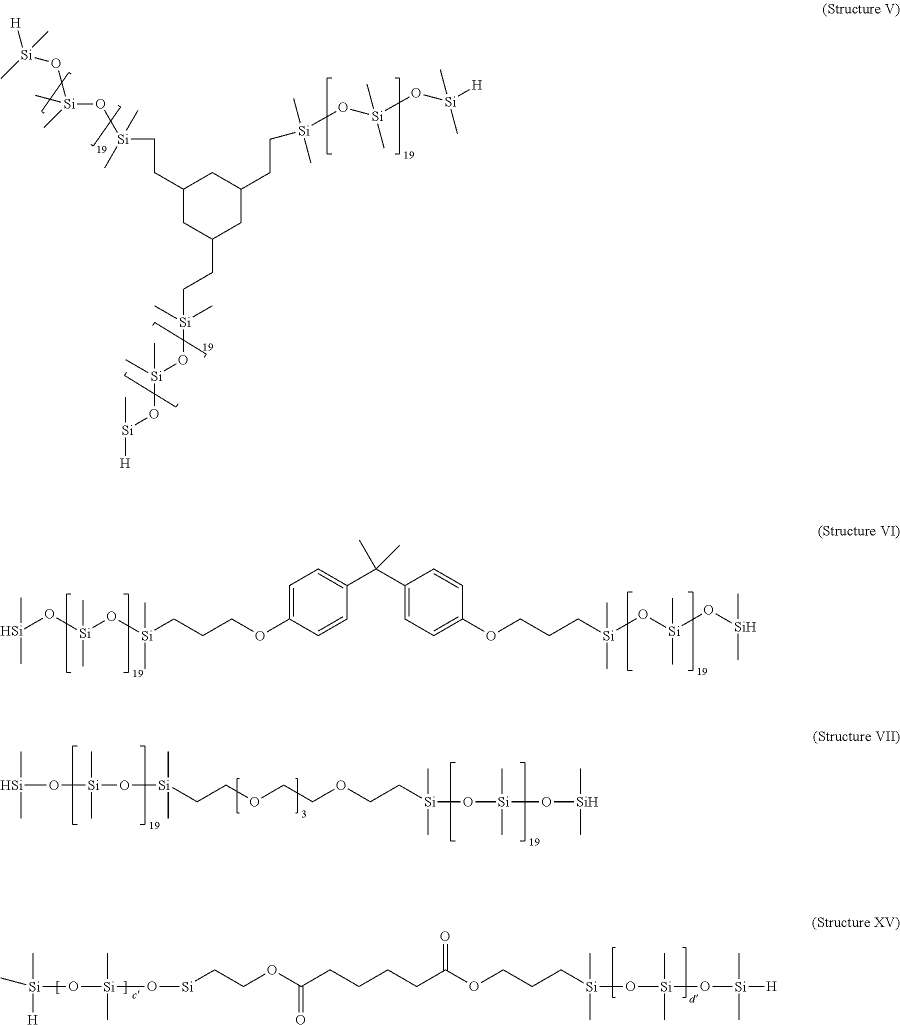

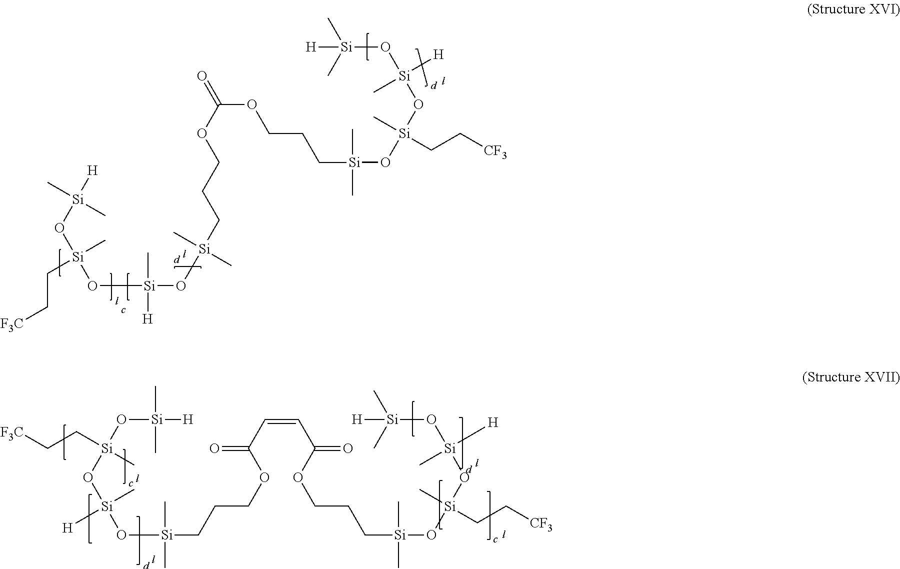

Various weight ratios of polymer A and polymer B are added to the composition to achieve desired properties for the hybrid composite. In one or more embodiments, the curable composition comprises the polymer A in a range from about 5% to 50%. In some embodiments, the curable composition comprises the polymer A in a range from about 8% to 50%. In some embodiments, the curable composition comprises the polymer A in a range from about 10% to 40%. In some embodiments, the curable composition comprises the polymer A in a range from about 10% to 30%. In some embodiments, the curable composition comprises the polymer A in a range from about 20% to 50%. In some embodiments, the curable composition comprises the polymer A in a range from about 20% to 40%. In some embodiments, the curable composition comprises the polymer A in a range from about 20% to 30%.

In one or more embodiments, the curable composition comprises the polymer B in a range from about 0.01% to 30%. In one or more embodiments, the curable composition comprises the polymer B in a range from about 1% to 30%. In some embodiments, the curable composition comprises the polymer B in a range from about 1% to 20%. In some embodiments, the curable composition comprises the polymer B in a range from about 1% to 15%. In some embodiments, the curable composition comprises the polymer B in a range from about 1% to 10%. In some embodiments, the curable composition comprises the polymer B in a range from about 2.5% to 10%. In some embodiments, the curable composition comprises the polymer B in a range from about 0.1% to 10%. In some embodiments, the curable composition comprises the polymer B in a range from about 0.01% to 10%.

As noted, the composition comprises one or more fillers, wherein the fillers include, but are not limited to, alumina, magnesia, ceria, hafnia, silicon, lanthanum oxide, neodymium oxide, samaria, praseodymium oxide, thoria, urania, yttria, zinc oxide, zirconia, silicon aluminum oxynitride, borosilicate glasses, barium titanate, silicon carbide, silica, boron carbide, titanium carbide, zirconium carbide, boron nitride, silicon nitride, aluminum nitride, titanium nitride, zirconium nitride, zirconium boride, titanium diboride, aluminum dodecaboride, barytes, barium sulfate, asbestos, barite, diatomite, feldspar, gypsum, hormite, kaolin, mica, nepheline syenite, perlite, phyrophyllite, smectite, talc, vermiculite, zeolite, calcite, calcium carbonate, wollastonite, calcium metasilicate, clay, aluminum silicate, talc, magnesium aluminum silicate, hydrated alumina, hydrated aluminum oxide, silica, silicon dioxide, titanium dioxide, glass fibers, glass flake, clays, exfoliated clays, or other high aspect ratio fibers, rods, or flakes, calcium carbonate, zinc oxide, magnesia, titania, calcium carbonate, talc, mica, wollastonite, alumina, aluminum nitride, graphite, graphene, metal coated graphite, metal coated graphene, aluminum powder, copper powder, bronze powder, brass powder, fibers or whiskers of carbon, graphite, silicon carbide, silicon nitride, alumina, aluminum nitride, silver, zinc oxide, carbon nanotubes, boron nitride nanosheets, zinc oxide nanotubes, black phosphorous, silver coated aluminum, silver coated glass, silver plated aluminum, nickel plated silver, nickel plated aluminum, carbon black of different structures, Monel mesh and wires, or combinations of two or more thereof.

In one or more embodiments, the fillers include graphite, nickel-coated graphite, silver, copper or combinations thereof. In one or more embodiments, the fillers include graphite, nickel-coated graphite, or a combination thereof. In one embodiment, the filler is a nickel-coated graphite.

Various weight ratios of fillers are added to the composition to achieve desired properties for the hybrid composite. In one or more embodiments, the curable composition comprises the fillers in a range from about 5% to 80%. In some embodiments, the curable composition comprises the fillers in a range from about 20% to 80%. In some embodiments, the curable composition comprises the fillers in a range from about 20% to 60%. In some embodiments, the curable composition comprises the fillers in a range from about 30% to 80%. In some embodiments, the curable composition comprises the fillers in a range from about 30% to 60%. In some embodiments, the curable composition comprises the fillers in a range from about 50% to 80%. In some embodiments, the curable composition comprises the fillers in a range from about 60% to 80%.

As noted, the curable composition comprises a catalyst suitable for promoting curing of the composition. Examples of suitable catalysts include, but are not limited to, transition metal complexes. Examples of suitable transition metals for the catalyst may include, but are not limited to, Pt, Ru, Rh, Fe, Ni, Co. The catalyst can be unsupported or immobilized on a support material, for example, carbon, silica, alumina, MgCl₂ or zirconia, or on a polymer or prepolymer, for example polyethylene, polypropylefle, polystyrene, or poly(aminostyrene)

In some embodiments, the composition comprises 0.0001 weight % to 0.1 weight %, 0.005 to 0.001 weight %, or 0.025 to 0.01 weight % of catalyst. In embodiments, the catalyst is provided in a PDMS solution. In some other embodiments, the composition comprises 0.0005 to 0.001 weight % of catalyst in PDMS. In some other embodiments, the composition comprises 0.001 weight % to 0.1 weight % of catalyst in PDMS. In some other embodiments, the composition comprises 0.005 weight % to 0.1 weight % of catalyst in PDMS.

In some embodiments, the composition further comprises a curing inhibitor. The curing inhibitors may include, but are not limited to, tetravinyltetramethylcyclo-tetrasiloxane, 2-methyl-3-Butinol-2, 1-ethynyl-cyclohexanol.

In some embodiments, the curable composition further comprises adhesion promoters selected from a trialkoxy epoxy silane, a trialkoxy primary amino silane, a combination of a primary and a secondary amine containing trialkoxy silane, a tris-(trialkoxy) isocyanurate based silane, an alkylthiocarboxylated trialkoxy silane, or a combination of two or more thereof.

In some embodiments, the curable composition further comprises a reactive diluent. The reactive diluent may include, but is not limited to, substituted glycidyl ether. The reactive diluent may include one or more solvents. Suitable solvents may include, but are not limited to, liquid hydrocarbons or silicone fluids. The hydrocarbon solvent may include a hexane or heptane, a silicone fluid may include polydiorganosiloxane.

In some embodiments, the curable composition further comprises a rheology modifier, or flow additives. The rheology modifier may include, but is not limited to, tetrahydrolinalool, thermoplastic resin and polyvinyl acetals. The flow additives may include, but is not limited silicone fluids, or acrylated copolymers.

Polymer A may be prepared using a silicone hydride and a vinyl-substituted alcohol in presence of Pt catalyst. In some embodiments, based on the degree of polymerization, bis-vinyltriethylene glycol, silicone dihydride, hexane and catalyst are charged in a 3-neck round bottom flask. Reaction temperature can be maintained around 65° C. with stirring. After equilibrating the temperature, the catalyst is charged in one shot. The reaction is continued to yield a vinyl siloxane.

Polymer B may be prepared using a siloxane and a substituted hydrocarbon in presence of Pt catalyst. In some embodiments, a siloxane-based silicone bonded di-hydrogen is homogenously mixed with Pt-catalyst at desired temperature. Then, alkenyl substituted hydrocarbon (e.g., 1,2,4-trivinylcyclohexane) is taken in a dropping funnel and added dropwise in to the homogeneous mixture of hydride and catalyst. The reaction is continued to yield a hydride terminated functionalized PDMS.

In some embodiments, Polymer A, Polymer B, filler(s), and catalyst are mixed together with respect to their vinyl and hydride equivalent weight followed by homogenizing at 2350 rpm using Hauschild speedmixer for 120 seconds. The homogenized mixture is cured at 60° C. in a hot air oven.

In one or more embodiments, the composition is cured by addition curing between 40-80° C. In one embodiment, the homogenized mixture is cured at 60° C.

In some embodiments, the application of the cured material and its end use is in coatings, adhesive, sealants, electrodes, ink, thermally conductive material, electrically conductive material, sensors, actuators, heating pad, antibacterial packaging material, conductive plastic, electromagnetic shielding material

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

### EXAMPLES

### Example 1 of Polymer A: Synthesis of Vinyl Functionalized PDMS of Structure (I)

Based on the degree of polymerization, bis-vinyltriethylene glycol (3.5 g), silicone dihydride (70 g), hexane (35 mL) and catalyst (10 ppm) were charged in a 3-neck round bottom container. Reaction temperature was maintained around 65° C. with stirring. After equilibrating the temperature, catalyst was charged to the mixture in one shot. The reaction was continued to yield polymer A, P6, which is polyether-based terminal di-vinyl siloxane of structure (I).

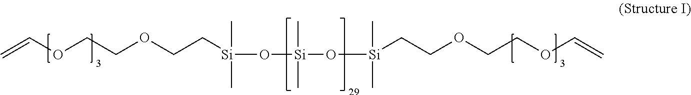

### Example 2 of Polymer A: Synthesis of Vinyl Terminated Functionalized Carbosilane of Structure (II)

Based on the degree of polymerization, silicone bonded di-hydrogen molecule (terminal hydride) was taken in a three neck round bottom container and stirred at >75° C. At the desired temperature, 5 ppm of Pt-catalyst was added into the round bottom container and allowed for homogenous mixing. Then, 1,3-divinyltetramethyldisiloxane was taken in a dropping funnel and allowed for dropwise addition in to the reaction mixture of hydride and catalyst. The molar ratio between silicone bonded di-hydrogen molecule (terminal hydride) and 1,3-Divinyltetramethyldisiloxane was taken as 1:1.01. The reaction was continued to yield bis vinyl terminated carbosilane structure (II).

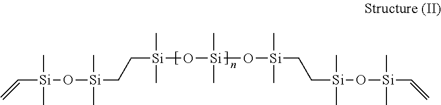 [SMILES: C=C[Si](C)(C)O[Si](C)(C)CC[Si](C)(C)O[Si](C)(C)O[Si](C)(C)CC[Si](C)(C)O[Si](C)(C)C=C]

### Example 3 of Polymer A: Synthesis of Vinyl Carbosilane of Structure (III)

Based on the degree of polymerization, heptamethylcyclotetrasiloxane was taken in a three neck round bottom container and stirred at >75° C. At the desired temperature, 5 ppm of Pt-catalyst was added into the round bottom container and allowed for homogenous mixing. Then, 1,3-divinyltetramethyldisiloxane was taken in a dropping funnel and allowed for dropwise addition in to the reaction mixture of hydride and catalyst. The molar ratio between heptamethylcyclotetrasiloxane (terminal hydride) and 1,3-Divinyltetramethyldisiloxane was taken as 1:1.01. The reaction was continued to yield vinyl terminated carbosilane structure (III).

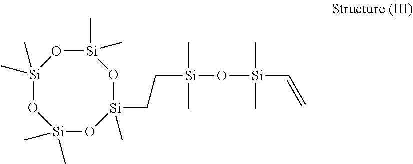 [SMILES: C=C[Si](C)(C)O[Si](C)(C)CC[Si]1(C)O[Si](C)(C)O[Si](C)(C)O[Si](C)(C)O1]

### Example 4 of Polymer B: Synthesis of Hydride Terminated Functionalized PDMS of Structure (IV)

Based on the degree of polymerization, siloxane-based silicone bonded di-hydrogen (1190 g) was taken in a three neck round bottom container and stirred at >75° C. At the desired temperature, 10 ppm of Pt-catalyst was added into the round bottom container and allowed for homogenous mixing. Then, triallyl 1,3,5 triazine (70 g) was taken in a dropping funnel and allowed for dropwise addition in to the reaction mixture of hydride and catalyst. The reaction was continued to yield hydride terminal triazine based terminal tris-hydride of structure (IV).

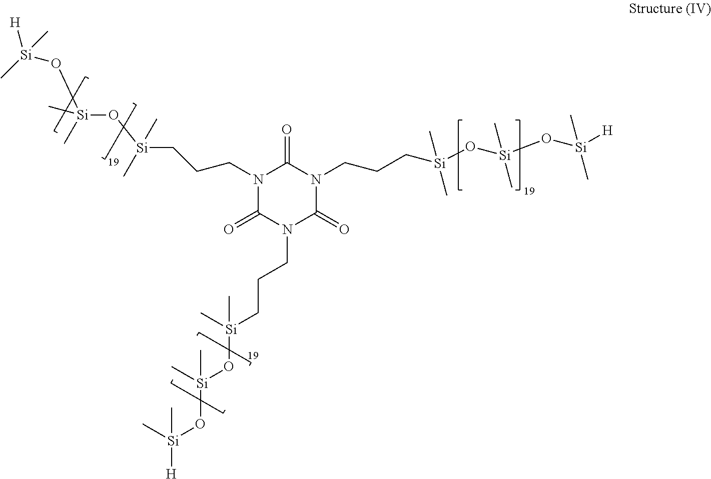

### Example 5 of Polymer B: Synthesis of Hydride Terminated Functionalized PDMS of Structure (V)

Based on the degree of polymerization, siloxane-based silicone bonded di-hydrogen (610 g) was taken in a three neck round bottom container and kept for stirring at >75° C. At the desired temperature 10 ppm Pt-catalyst was added into the round bottom container and allowed for homogenous mixing. Then 1,2,4-trivinylcyclohexane (35 g) was taken in a dropping funnel and allowed for dropwise addition in to the reaction mixture of hydride and catalyst. The reaction was continued to yield cyclohexane based terminal tris-hydride of structure (V).

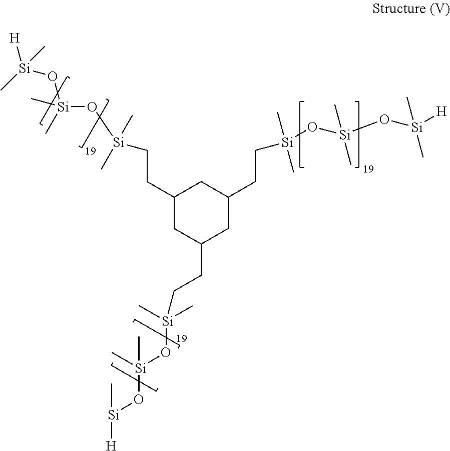

### Example 6 of Polymer B: Synthesis of Hydride Terminated Functionalized PDMS of Structure (VI)

Based on the degree of polymerization, siloxane-based silicone bonded di-hydrogen (197.8 g) was taken in a three neck round bottom container and kept for stirring at >75° C. At desired temperature 10 ppm Pt-catalyst was added into the round bottom container and allowed for homogenous mixing. Then 2,2′-Diallyl bisphenol A (175 g) was taken in a dropping funnel and allowed for dropwise addition in to the reaction mixture of hydride and catalyst. The reaction was continued to yield bisphenol A based terminal bis-hydride of structure (III).

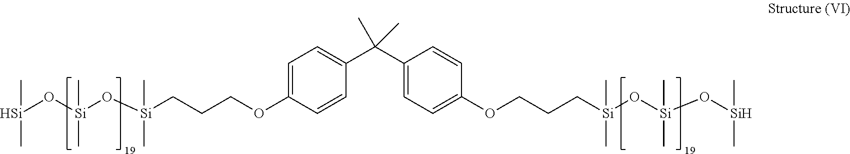

### Example 7 of Polymer B: Synthesis of Hydride Terminated Functionalized PDMS of Structure (VII)

Based on the degree of polymerization, bishydride terminated PDMS (21.51 g) and triethylene glycol divinyl ether (5.0 g) was charged in a round bottom flask, equipped with a reflux condenser, a thermometer jacket and a nitrogen inlet. The mixture was heated to 40° C. 10-15 ppm of Karstedt's catalyst was introduced in the reaction mixture and the reaction continued to yield hydride terminal linear polymer of structure (VII).

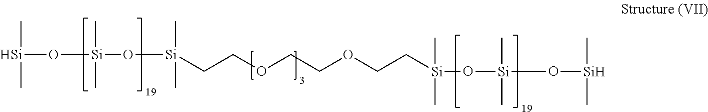

### Summary of Materials

Table 1 provides the descriptions and the sources of different materials used in the formulation in addition to the aforementioned structures (I-VII).

TABLE 1
Description and the source of materials

| | Description | Source |
|---|---|---|
| Polymer A (Label)* | | |
| Silopren^{#} U0.2 (A1) | Bisvinyl terminated silicone | Momentive Performance |
| | fluid of viscosity 0.2 Pa-S | Materials, Leverkusen, Germany |
| Silopren^{#} U10 (A2) | Bisvinyl terminated silicone | Momentive Performance |
| | fluid of viscosity 10 Pa-S | Materials, Leverkusen, Germany |
| Silopren^{#} U65 (A3) | Bisvinyl terminated silicone | Momentive Performance |
| | fluid of viscosity 65 Pa-S | Materials, Leverkusen, Germany |
| FF 160^{#} (A4) | Bis-vinyl terminated silicone | Momentive Performance |
| | with pendant CF₃ fluid of | Materials, Tarrytown, USA |
| | viscosity 20 Pa-S | |
| A5 | Structure I | In house synthesizes |
| A6 | Structure II | In house synthesizes |
| A7 | Structure III | In house synthesizes |
| A6 | Vinyl MD Resin | Momentive Performance |
| | | Materials, Leverkusen, Germany |
| Polymer B (Label)* | | |
| B1 | Structure IV | In house synthesizes |
| B2 | Structure V | In house synthesizes |
| B3 | Structure VI | In house synthesizes |
| B4 | Structure VII | In house synthesizes |
| B5 | Silicone Hydride Fluid | Momentive Performance |
| | | Materials, Leverkusen, Germany |
| Filler (Label)* | | |
| Nickel Coated Graphite (f1) | Mesh size 100 with Nickel to | Fischer Scientific, USA |
| | Carbon ratio of 60:40 | |
| Barium Titanate (f2) | Nanopowder < 100 nm | SRL Chemical, India |
| Iron Oxide (f3) | Nanopowder < 50-100 nm | Sigma Aldrich, USA |
| Nickel coated Aluminum | Powder 80-100 μm, Nickel to | Oerlikon, Canada |
| | Aluminum ratio of 80:20 | |
| Karstedt's Catalyst (Cat.) | 2 wt and 10 wt % in Xylene | Sigma Aldrich, USA |
| | solution | |

^{#}Momentive's commercial material
*Label- is used herein for describing the formulations.

### Preparation of Various Formulations

The polymer A comprising one or more alkenyl and/or epoxy functional groups and polymer B comprising two or more hydride functional groups were used to prepare hybrid silicone composites in presence of one or more fillers and a catalyst. Here, the hydride functionality could be in either terminal or pendent to the siloxane molecule. Further, fillers of various weight ratios were added.

Both alkenyl functional polymers A and hydride functional polymers B were added by varying the hydride to vinyl ratio, and filler was added to the mixture to provide the formulations. The formulations were prepared by homogenizing the mixture in the presence of Pt-catalyst. A series of examples were prepared by using the formulated materials using high speed mixer at 2000 rpm for 30-60 seconds. The mixture was then coated over a PET sheet and allowed to cure thermally at 80° C. or by compression molding at 150° C.

The details of the various formulations are described below in Table 2. For different formulations, different types of silicone alkenyl, fluorosilicone alkenyl, organic-silicone hybrid alkenyl, silicone hydride and hybrid silicone hydride were selected.

TABLE 2
Representative examples and their composition

| | Polymer A | | Polymer B | | Filler | |
|---|---|---|---|---|---|---|
| Formulation | | Percentage in | | Percentage in | | Percentage in |
| No. | Label | formulation | Label | formulation | Label | formulation |
| F1 | A3 | 29 | B1 | 1 | f1 | 70 |
| F2 | A2 | 27.4 | B1 | 2.6 | f1 | 70 |
| F3 | A1 | 21.9 | B1 | 8.1 | f1 | 70 |
| F4 | A2 | 27.5 | B2 | 2.5 | f1 | 70 |
| F5 | A1 | 21.9 | B2 | 8.1 | f2 | 70 |
| F6 | A4 | 24.1 | B1 | 5.8 | f1 | 70 |
| F7 | A6 | 19.8 | B1 | 10.1 | f1 | 70 |
| F8 | A3, A7 | 21.2, 0.53 | B1 | 8.2 | f1 | 70 |
| F9 | A3 | 25.5 | B1 | 4.5 | f1, f2 | 69, 1 |
| F10 | A3 | 25.5 | B1 | 4.5 | f1, f3 | 69, 1 |
| F11 | A5 | 23.6 | B1, B4 | 5.4, 1 | f1 | 70 |
| F12 | A3 | 28.5 | B1, B3 | 0.04, 1.46 | f1 | 70 |
| F13 | A3, A6 | 17.7, 9.12 | B1, B5 | 0.5, 1.8 | f5 | 70 |

### Physico Mechanical Property Testing Methodology

EMI Shielding Measurement: The EMI shielding measurement for the samples of different forms were done as per the IEEE299 standard: The samples were tested in the frequency range of 6-12 GHz. The thickness of the sample was maintained in between 0.5-2 mm.

The electrical resistivity measurement for the samples of different forms were done as per the ASTM D257 standard using the four-probe instrument. The obtained electrical resistivity value was transposed to electrical conductivity.

Thermal Conductivity: The thermal conductivity measurement of the samples was done following the ASTM E1530 standard.

The mechanical properties of the developed formulations were measured using the ASTM D412 standard. Instron instrument was used for the same. The hardness of the developed composites was measured according to ASTM D2240 standard.

TABLE 3
Property of the developed formulations

| Formu- | Electrical | Thermal | Tensile | Elongation | |
|---|---|---|---|---|---|
| lation | Conductivity | Conductivity | Str. | @ Break | Hardness |
| No. | (S/cm) | (W/mK) | (MPa) | (%) | (Shore A) |
| F1 | 0.091 | 0.97 | 0.189 | 269 | 14 |
| F2 | 0.05 | 1.0 | 0.219 | 180 | 15 |
| F3 | 0.05 | 1.83 | 0.233 | 93 | 23 |
| F4 | 0.40 | 0.91 | 0.224 | 269 | 17 |
| F5 | 0.312 | 1.11 | 0.461 | 110 | 34 |
| F6 | 0.17 | 1.5 | 0.243 | 76 | 25 |
| F7 | 0.01 | 1.09 | 0.271 | 83 | 44 |
| F8 | 0.01 | 1.2 | 0.341 | 99 | 50 |
| F9 | 0.007 | 1.68 | 0.394 | 87 | 46 |
| F10 | 0.012 | 1.5 | 0.367 | 155 | 38 |
| F11 | 13 | — | 0.984 | 70 | 56 |
| F12 | 0.08 | — | 0.85 | 81 | 61 |
| F13 | 0.66 | — | 2.56 | 106 | 45 |

In one of the embodiments, F13 demonstrated a lap shear strength of 1.1 MPa (Aluminum to Aluminum).

TABLE 4
EMI Shielding Effectiveness of various formulations

| Formulation No. | EMI Shielding (dB) |
|---|---|
| F2 | 80 |
| F3 | 71 |
| F5 | 102 |
| F6 | 100 |
| F14 | 50 |

### Comparative Example 1

For drawing the comparison of the hybrid silicone-based formulation to that of the pure silicone-based comparison, controlled sample (comparative to formulation F13) was made and tested at a similar vinyl to hydride ratio. Siloxane based crosslinker was taken and U65 was taken as the base polymer while pure silicone hydride based crosslinker (CB) was used in the control sample.

TABLE 5
Comparative Example 1

| | Polymer A | | Polymer B | | Filler | | Electrical | | |
|---|---|---|---|---|---|---|---|---|---|
| Formulation | | Percentage in | | Percentage in | | Percentage in | Conductivity | EMI SE | Elongation |
| No. | Label | formulation | Label | formulation | Label | formulation | (S/cm) | (dB) | at Break |
| Control | A3 | 29.7 | CB | 0.3 | f1 | 70 | 0.002 | 40 | 81 |
| F14 | A3 | 25.5 | B1 | 4.5 | f1 | 70 | 0.18 | 50 | 269 |

Embodiments of the present technology have been described above and modification and alterations may occur to others upon the reading and understanding of this specification. The claims as follows are intended to include all modifications and alterations insofar as they come within the scope of the claims or the equivalent thereof.

1. A curable silicone composition, comprising:
(i) a polymer A of Formula 1;
(ii) a polymer B of Formula 2;
(iii) a filler, and
(iv) a catalyst;
wherein the curable silicone composition is an addition cure system; and
wherein the cured form of the curable composition is a conductive material,
(R)ₐ(W)_{b}(R)_{a″} Formula 1;
wherein a and a″ can be zero or greater with the proviso that va+a″>0, and b is greater than zero, wherein R is represented by Formula (1a):
(CH₂)_{c}(CH₂O)_{d}(CHOH)ₑ(S)_{f}(X)_{g} Formula (1a)
wherein, S is independently selected from a urea or a urethane linkage, a saturated cyclic hydrocarbon, an unsaturated cyclic hydrocarbon, a heterocyclic group, a sulphone, a carbonate, a maleate, a phthalate, an adipate, and
wherein X is represented by Formula (1b), Formula (1b′), or a combination of alkenyl radical of Formula (1b) and any one of the ring structures of Formula (1b′): 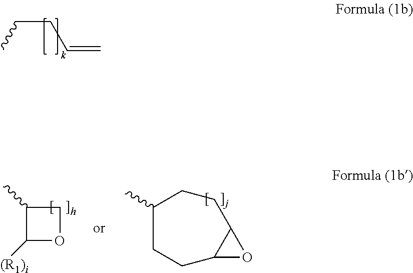
wherein R₁ is selected from an aliphatic or an aromatic-substituted hydrocarbons, or an un-substituted hydrocarbon, or fluorinated hydrocarbons having 1-20 carbon atoms, and optionally connected to an ester, wherein c, g d, e, f, h, i, j, k can be zero or greater;
W of Formula 1 is represented by Formula (1c):
(Y)ₗ(Z)ₘ Formula (1c)
wherein l, m can be zero or greater with the proviso that (l+m)>0; Yin Formula (1c) is represented by Formula (1d)
(M₁)ᵤ(D₁)ₙ(D₂)ₒ(D*)ₚ(T₁)_{q}(Q₁)ᵣ(M₂)ᵥ Formula (1d)
wherein n, o are each always >0, where u, p, q, r, and v can be zero or greater with the proviso that n+o+p+q+r+u+v>0;
M₁ is represented by Formula (1e)
R₂R₃R₄SiK_{1/2} Formula (1e)
D₁ is represented by Formula (1f):
R₅R₆SiK_{2/2} Formula (1f)
D₂ is represented by Formula (1g):
R₇R₈SiK_{2/2} Formula (1g)
D* is represented by Formula (1h) 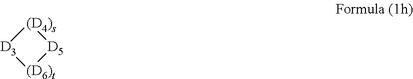
D₃ is represented by Formula (1i)
R₉R₁₀SiK_{2/2} Formula (1i)
D₄ is represented by Formula (1j)
R₁₁R₁₂SiK_{2/2} Formula (1j)
D₅ is represented by Formula (1k)
R₁₃R₁₄SiK_{2/2} Formula (1k)
D₆ is represented by Formula (1l)
R₁₅R₁₆SiK_{2/2} Formula (1l)
T₁ is represented by Formula (1m):
R₁₇SiK_{3/2} Formula (1m)
Q₁ is represented by Formula (1n):
SiK_{4/2} Formula (1n)
M₂ is represented by Formula (1o):
R₁₈R₁₉R₂₀SiK_{1/2} Formula (1o)
wherein R₂-R₂₀ can be independently selected from R, a monovalent cyclic or acyclic, aliphatic or aromatic, substituted or un-substituted hydrocarbon, or a fluorinated hydrocarbon having 1-20 carbon atoms, s and t can be zero or greater;
wherein K is oxygen or (CH₂) group subject to the limitation that the molecule contains an even number of O_{1/2} and even number of (CH₂)_{1/2} and the O_{1/2} and (CH₂)_{1/2} groups both are all paired in the molecule,
wherein Z in Formula (1c) is selected from the structure of Formula (1p):
R₂₁(J)_{w}R₂₂ Formula (1p)
wherein J is independently selected from a monovalent cyclic or acyclic, aliphatic or aromatic, substituted or un-substituted hydrocarbon, or a fluorinated hydrocarbon having 1-20 carbon atoms, optionally connected to heteroatom,
wherein R₂₁, R₂₂ are independently selected from R or from a monovalent cyclic or acyclic, aliphatic or aromatic, substituted or un-substituted hydrocarbon, or a fluorinated hydrocarbon having 1-20 carbon atoms, optionally connected to a heteroatom,
wherein, the polymer B can be represented by Formula 2:
(R′)_{a′}(W′)_{b′}(R′)_{a′} Formula (2)
wherein a′, b′ are each greater than 0,
R′ can be represented by Formula (2a)
(M₃)_{l′}(D₇)_{c′}(D₈)_{d′}(D**)_{e′}(T₂)_{f′}(Q₂)_{g′}(M₄)_{m′} Formula (2a)
M₃ is represented by Formula (2b)
R₂₅R₂₆R₂₇SiK′_{1/2} Formula (2b)
D₇ is represented by Formula (2c)
R₂₈R₂₉SiK_{2/2} Formula (2c)
D₈ is represented by Formula (2d)
R₃₀R₃₁SiK_{2/2} Formula (2d)
D** is represented by Formula (2e) 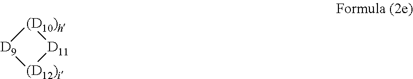
D₉ is represented by Formula (2f)
R₃₂R₃₃SiK′_{2/2} Formula (2f)
D₁₀ is represented by Formula (2g)
R₃₄R₃₅SiK′_{2/2} Formula (2g)
D₁₁ is represented by Formula (2h)
R₃₆R₃₇SiK_{2/2′} Formula (2h)
D₁₂ is represented by Formula (2i)
R₃₈R₃₉SiK′_{2/2} Formula (2i)
T₂ is represented by Formula (2j)
R₄₀SiK_{3/2′} Formula (2j)
Q₂ is represented by Formula (2k)
SiK_{4/2} Formula (2k)
M₄ is represented by Formula (2l)
R₄₁R₄₂R₄₃SiK′_{1/2} Formula (2l)
R₂₅-R₄₃ are independently selected from hydrogen, a monovalent cyclic or acyclic, aliphatic or aromatic, substituted or un-substituted hydrocarbon, or a fluorinated hydrocarbon having 1-20 carbon atoms, c′, d′ is always >0, while e′, f′, m′ and g′ can be zero with the proviso that c′+d′+e′+f+g′+l′+m′>0, h′, i′>0 when e′>0, K′ is oxygen or a (CH₂) group subject to the limitation that the molecule contains an even number of O_{1/2} and even number of (CH₂)_{1/2} and the O_{1/2} and (CH₂)_{1/2} groups both are all paired in the molecule;
wherein W′ of Formula 2 is selected from the structure of Formula (2m) or Formula (2m′): 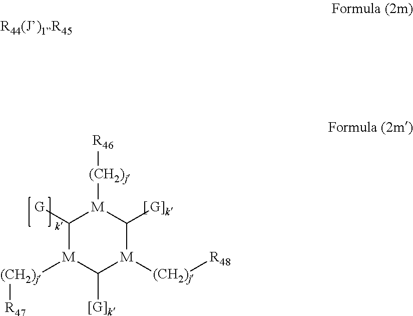
wherein J′ is independently selected from a divalent cyclic or acyclic, aliphatic or aromatic, substituted or un-substituted hydrocarbon, or a fluorinated hydrocarbon having C₁-C₂₀ carbon atoms, optionally connected to heteroatom, l″≥0;
wherein R₄₄-R₄₈ can be independently selected from R′ or from a monovalent cyclic or acyclic, aliphatic or aromatic, substituted or un-substituted hydrocarbon, or a fluorinated hydrocarbon having 1-20 carbon atoms, optionally connected to heteroatom; G is a heteroatom selected from oxygen; M is independently selected from carbon or nitrogen, k′ is 0 or greater, and j′ is greater than 1.

2. The curable silicone composition of claim 1, wherein Formula (1a) is selected from a linear chain, a branched chain, or a cyclic structure.

3. The curable silicone composition of claim 2, wherein a cyclic structure represented in Formula (2m′) is cycloaliphatic, or aromatic, and optionally contains heteroatoms.

4. The curable silicone composition of claim 2, wherein the R₂₁, R₂₂ of Formula (1p) of polymer A and R₄₄-R₄₅ of Formula (2m) of polymer B is independently selected from tri(ethylene glycol), di(ethylene glycol), sulphone, carbonate, maleate, phthalate, adipate, urea, polyether, and perfluoropolyether.

5. The curable silicone composition of claim 2, wherein the polymer B, as represented by Formula 2, is used as a cross-linker, or a chain extender.

6. The curable silicone composition of claim 2, wherein the polymer B, as represented by Formula 2, is selected from a linear polymer, or a branched polymer.

7. The curable silicone composition of claim 2, wherein the polymer B, as represented by Formula 2, is a branched polymer.

8. The curable silicone composition of claim 7, wherein W′ of Formula 2 is selected from the structure of Formula (2m′).

9. The curable silicone composition of claim 7, wherein W′ of Formula 2 is selected from silyl hydride of triazine, or silyl hydride of cyclohexane.

10. The curable silicone composition of claim 1, wherein the polymer A is present in a range from about 5% to 50% by weight based on the total weight of the composition.

11. The curable silicone composition of claim 1, wherein the polymer B is present in a range from about 0.01% to 30% by weight based on the total weight of the composition.

12. The curable silicone composition of claim 1, wherein the filler is selected from a group consisting of alumina, magnesia, ceria, hafnia, silicon, lanthanum oxide, neodymium oxide, samaria, praseodymium oxide, thoria, urania, yttria, zinc oxide, zirconia, silicon aluminum oxynitride, borosilicate glasses, barium titanate, silicon carbide, silica, boron carbide, titanium carbide, zirconium carbide, boron nitride, silicon nitride, aluminum nitride, titanium nitride, zirconium nitride, zirconium boride, titanium diboride, aluminum dodecaboride, barytes, barium sulfate, asbestos, barite, diatomite, feldspar, gypsum, hormite, kaolin, mica, nepheline syenite, perlite, phyrophyllite, smectite, talc, vermiculite, zeolite, calcite, calcium carbonate, wollastonite, calcium metasilicate, clay, aluminum silicate, talc, magnesium aluminum silicate, hydrated alumina, hydrated aluminum oxide, silica, silicon dioxide, titanium dioxide, glass fibers, glass flake, clays, exfoliated clays, calcium carbonate, zinc oxide, magnesia, titania, calcium carbonate, talc, mica, wollastonite, alumina, aluminum nitride, graphite, graphene, metal coated graphite, metal coated graphene, aluminum powder, copper powder, bronze powder, brass powder, fibers or whiskers of carbon, graphite, silicon carbide, silicon nitride, alumina, aluminum nitride, silver, zinc oxide, carbon nanotubes, boron nitride nanosheets, zinc oxide nanotubes, black phosphorous, silver coated aluminum, silver coated glass, silver plated aluminum, nickel plated silver, nickel plated aluminum, carbon black of different structures, monel mesh, monel wires, or combinations of two or more thereof.

13. The curable silicone composition of claim 1, wherein the filler is present in a range from about 5% to 80% by weight based on the total weight of the composition.

14. The curable silicone composition of claim 1, further comprising a catalyst selected from B, Pt, Ru, Rh, Fe, Ni, or Co.

15. The curable silicone composition of claim 14, wherein the catalyst is present in a range from about 0.0001 weight % to about 5 weight % based on the total weight of the composition.

16. The curable silicone composition of claim 1, further comprising a curing inhibitor selected from tetravinyltetramethylcyclo-tetrasiloxane, 2-methyl-3-Butinol-2, or 1-ethynyl-cyclohexanol.

17. The curable silicone composition of claim 1, further comprising an adhesion promoter selected from the group consisting of trialkoxy epoxy silane, a trialkoxy primary amino silane, a combination of a primary and a secondary amine containing trialkoxy silane, a tris-(trialkoxy) isocyanurate based silane, an alkylthiocarboxylated trialkoxy silane, and a combination of two or more thereof.

18. The curable silicone composition of claim 1, further comprising a reactive diluent selected from the group consisting of substituted glycidyl ether, liquid hydrocarbons, silicone fluids, and combinations thereof.

19. The curable silicone composition of claim 1, further comprising a rheology modifier selected from the group consisting of alkanes, silanes, silicones, acrylic copolymers, glycols, polyols, ethers, esters, polyesters, alcohols, amides, polyamides, amines, polyamines, imines, polyimines, urethanes, polyurethanes, ketones, polyketones, saccharides, polysaccharides, cellulose, fluorocompounds, thermoplastic or thermosetting resins, polyvinyls, synthetic or natural oils, naturally occurring additives, guar, xanthanes, alginates, lactates, lactides, anhydrides, gums, silicates, borates, oxides, sulfides, sulfates and combinations thereof.

20. A cured material formed from the curable composition of claim 1.

21. The cured material of claim 20, wherein the cured material is thermally conductive, electrically conductive, or a combination thereof.

22. The cured material of claim 20, wherein the cured material has an electromagnetic interference (EMI) shielding efficiency between 50 to 170 dB.

23. The cured material of claim 20, wherein the cured material is in the form of a coating, adhesive, sealant, electrode, ink, thermally conductive material, electrically conductive material, sensor, actuator, heating pad, antibacterial packaging material, conductive plastic, or electromagnetic shielding material.

24. A method of making a silicone polymer material comprising:
(i) mixing the Polymer A and the Polymer B from claim 1 to form a mixture;
(ii) homogenizing the mixture for a period of time to form a homogenized mixture; and
(iii) curing the homogenized mixture by addition curing.

25. A curable silicone composition, comprising:
(i) a polymer A comprising one or more alkenyl and/or epoxy functional groups;
(ii) a polymer B comprising one or more hydride functional groups;
(iii) a filler, and
(iv) a catalyst;
wherein the polymer A and polymer B are silicone polymers, and the curable silicone composition is an addition cure system, and
wherein the cured form of the curable composition is a conductive material.

26. A curable silicone composition of claim 25, wherein the polymer B is a hydride terminated functional silicone.

27. A method of making a silicone composition comprising:
(i) mixing of a Polymer A comprising one or more alkenyl functional groups, a Polymer B comprising one or more hydride functional groups, one or more filler(s), and a catalyst together with respect to vinyl equivalent weight of the polymer A and hydride equivalent weight of polymer B to form a mixture;
(ii) the mixture is then homogenized to form a homogenized mixture; and
(iii) the homogenized mixture is then cured by adding an addition cure catalyst,
wherein the polymer A and polymer B are silicone polymers and
wherein the cured form of the curable composition is a conductive material.
